(19) United States
(12) Patent Application Publication
(10) Pub. No.: US 2026/0065692 A1
(43) Pub. Date: Mar. 5, 2026

(54) AUTOMOTIVE STORAGE DEVICE, VEHICLE SYSTEM INCLUDING AUTOMOTIVE STORAGE DEVICE, AND VEHICLE INCLUDING THE SAME

(71) Applicant: Samsung Electronics Co., Ltd., Suwon-si (KR)

(72) Inventor: Seungcheol LEE, Suwon-si (KR)

(73) Assignee: Samsung Electronics Co., Ltd., Suwon-si (KR)

(21) Appl. No.: 19/082,500

(22) Filed: Mar. 18, 2025

(30) Foreign Application Priority Data
Sep. 3, 2024 (KR) 10-2024-0119268

(51) Int. Cl. G06V 20/58; B60W 60/00; G01S 13/06; G01S 19/40

(52) U.S. Cl. CPC G06V 20/582; B60W 60/001; G01S 13/06; G01S 19/40

(57) ABSTRACT

An automotive storage device according to the present disclosure includes a non-volatile memory device configured to store map information including road information, and a storage controller configured to receive a first image data obtained by capturing a proper noun sign and position information of a vehicle, generate proper noun sign information about letters of the proper noun sign based on the first image data, modify the position information based on the road information and the proper noun sign information when an accuracy distance of the position information exceeds a threshold distance, and generate proper noun sign position information including the modified position information and the proper noun sign information.

### CROSS-REFERENCE TO RELATED APPLICATION

This application claims priority to and the benefit of Korean Patent Application No. 10-2024-0119268 filed at the Korean Intellectual Property Office on Sep. 3, 2024, the entire contents of which are incorporated herein by reference.

### BACKGROUND

### (a) Field

The present disclosure relates to automotive storage devices, vehicle systems including the automotive storage device, and vehicles including the same.

### (b) Description of the Related Art

As autonomous driving advances, a need for map information to guide vehicles is increasing. Map information may include information about traffic signs, maximum and minimum speeds on roads, or the like. Map information may support safe autonomous driving by providing a variety of information desired for autonomous driving of vehicles, so it is desirable to include a variety of information about the surroundings of the road on which the vehicle is traveling.

### SUMMARY

Some example embodiments provide automotive storage devices capable of supporting data processing of an autonomous driving system that controls autonomous driving of a vehicle.

An automotive storage device according to an example embodiment of the present disclosure includes a non-volatile memory device configured to store map information, the map information including road information, and a storage controller configured to receive a first image data obtained by capturing a proper noun sign and position information of a vehicle, generate proper noun sign information about letters of the proper noun sign based on the first image data, modify the position information based on the road information and the proper noun sign information when an accuracy distance of the position information exceeds a threshold distance, and generate proper noun sign position information including the modified position information and the proper noun sign information.

A vehicle system according to an example embodiment includes a global navigation satellite system (GNSS) receiver configured to generate position information of a vehicle, a first camera configured to generate a first image information obtained by capturing a proper noun sign, an autonomous driving system configured to generate a first image data based on the first image information, and an automotive storage device configured to generate proper noun sign information about letters included in the proper noun sign based on the first image data, provide a request signal requesting additional information to the autonomous driving system when an accuracy distance of the position information exceeds a threshold distance, modify the position information based on the additional information received from the autonomous driving system, and generate proper noun sign position information including the modified position information and the proper noun sign information.

A vehicle according to an example embodiment includes a global navigation satellite system (GNSS) receiver configured to generate a first position information of the vehicle, a camera configured to generate image information obtained by capturing an external image of the vehicle, an autonomous driving system configured to generate image data based on the image information, and an automotive storage device including a non-volatile memory device and a storage controller, the non-volatile memory device configured to store proper noun sign position information including proper noun sign information and information regarding a position of a proper noun sign, the storage controller configured to identify the proper noun sign included in the external image of the vehicle based on the image data, generate second position information regarding the position of the proper noun sign based on the proper noun sign position information when an accuracy distance of the first position information exceeds a threshold distance, and provide the second position information to the autonomous driving system.

### BRIEF DESCRIPTION OF THE DRAWINGS

FIG. 1 illustrates a vehicle including an automotive storage device according to an example embodiment.

FIG. 2 illustrates an automotive storage device according to an example embodiment.

FIG. 3 illustrates an autonomous driving system according to an example embodiment.

FIG. 4 illustrates an automotive storage device for storing image data according to an example embodiment.

FIG. 5 illustrates the operation of an automotive storage device according to an example embodiment.

FIG. 6 illustrates an automotive storage device generating proper noun sign position information according to an example embodiment.

FIGS. 7 and 8 illustrate an automotive storage device that modifies position information based on a map and proper noun sign information according to an example embodiment.

FIGS. 9 and 10 illustrate an automotive storage device that modifies position information based on RADAR information or LiDAR information according to an example embodiment.

FIGS. 11 and 12 illustrate an automotive storage device that modifies position information based on additional external images received from a front-left camera and a front-right camera according to an example embodiment.

FIGS. 13 and 14 illustrate an automotive storage device that modifies position information based on additional external images received from a front camera according to an example embodiment.

FIG. 15 illustrates an automotive storage device that provides a second position information generated based on proper noun sign position information according to an example embodiment to an autonomous driving system.

FIG. 16 is a flowchart illustrating an automotive storage device generating proper noun sign position information according to an example embodiment.

FIG. 17 is a flowchart illustrating an automotive storage device that modifies position information based on additional information according to an example embodiment.

FIG. 18 is a flowchart illustrating an automotive storage device that outputs second position information generated based on proper noun sign position information according to an example embodiment.

FIG. 19 illustrates a non-volatile memory device according to an example embodiment.

### DETAILED DESCRIPTION

The present disclosure will be described in detail hereinafter with reference to the accompanying drawings, in which some example embodiments of the present disclosure are shown. As those skilled in the art would realize, the described example embodiments may be modified in various different ways, without departing from the spirit or scope of the present disclosure.

The drawings and description are to be regarded as illustrative in nature and not restrictive, and like reference numerals designate like elements throughout the specification.

In addition, unless explicitly stated to the contrary, the word “comprise,” and variations such as “comprises” and “comprising,” should be understood to imply the inclusion of stated elements but not the exclusion of any other elements.

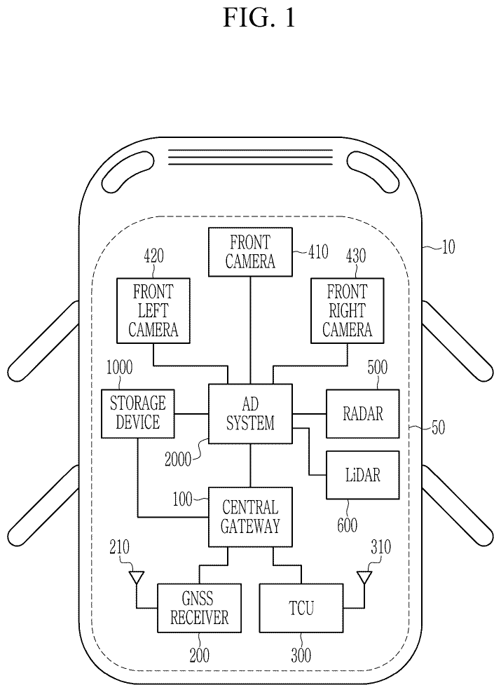

FIG. 1 illustrates a vehicle including an automotive storage device according to an example embodiment.

Referring to FIG. 1, a vehicle 10 may include a vehicle system 50. The vehicle system 50 may include a central gateway 100, a global navigation satellite system (GNSS) receiver 200, a telematics communication unit (TCU) 300, a front camera 410, a front-left camera 420, a front-right camera 430, a radio detection and ranging (RADAR) sensor 500, a light detection and ranging (LiDAR) sensor 600, an automotive storage device 1000, and an autonomous driving (AD) system 2000.

In an example embodiment, the central gateway 100 may be connected to a GNSS receiver 200, a telematics communication unit 300, the automotive storage device 1000, and an autonomous driving system 2000. The central gateway 100 may provide data received from the GNSS receiver 200 or the telematics communication unit 300 to the automotive storage device 1000 and the autonomous driving system 2000. The central gateway 100 may provide data received from the automotive storage device 1000 and the autonomous driving system 2000 to the telematics communication unit 300.

In an example embodiment, the GNSS receiver 200 may receive satellite signals from an artificial satellite through an antenna 210. The GNSS receiver 200 may generate GNSS position information about the position of the vehicle 10 based on satellite signals. GNSS position information may include position information indicated by latitude and longitude, heading angle information indicating the direction in which the vehicle is traveling, and accuracy information indicating the accuracy of the position. Accuracy information may be a distance representing the error range of the position information included in the GNSS position information.

In an example embodiment, the telematics communication unit 300 may communicate with an external server via an antenna 310. The telematics communication unit 300 may provide data generated inside of the vehicle 10 to an external server via the antenna 310 or receive data from the external server.

In an example embodiment, the front camera 410 may generate front image information obtained by capturing a front image outside of the vehicle 10. In an example embodiment, the front-left camera 420 may generate front-left image information obtained by capturing a front-left image outside of the vehicle 10. The front-right camera 430 may generate front-right image information obtained by capturing a front-right image outside of the vehicle. In an example embodiment, the front camera 410, the front-left camera 420, and the front-right camera 430 may capture a sign in front of the vehicle 10 and generate front image information about the captured sign.

In an example embodiment, the front camera 410, the front-left camera 420, and the front-right camera 430 may provide front image information, front-left image information, and front-right image information to the autonomous driving system 2000.

In an example embodiment, the RADAR sensor 500 may emit electromagnetic waves to the outside of the vehicle 10. The RADAR sensor 500 may receive reflected waves that are reflected when electromagnetic waves collide with objects outside of the vehicle 10 and generate RADAR information based on the electromagnetic waves and reflected waves. In an embodiment, RADAR information may be information used to calculate the distance between the vehicle 10 and an object. In an example embodiment, the RADAR information may include information about the time at which the electromagnetic waves were emitted, the frequency of the electromagnetic waves, the time at which the reflected waves were received, and the frequency of the reflected waves.

In an example embodiment, the LiDAR sensor 600 may emit a laser pulse to the outside of the vehicle 10. In an example embodiment, the LiDAR sensor 600 may receive reflected waves of a laser pulse reflected from an object outside of the vehicle 10 and generate LiDAR information based on the laser pulse and the reflected waves.

In an example embodiment, the LiDAR information may be information used to calculate the distance between a vehicle and an object.

In an example embodiment, the autonomous driving system 2000 may control autonomous driving of the vehicle 10. In an example embodiment, the autonomous driving system 2000 may control the front camera 410, the front-left camera 420, the front-right camera 430, the RADAR sensor 500, and/or the LiDAR sensor 600.

In an example embodiment, the autonomous driving system 2000 may generate image data processed with image information received from the front camera 410, the front-left camera 420, and the front-right camera 430. For example, the autonomous driving system 2000 may perform image preprocessing, such as removing noise from an original image and adjusting contrast, and color-based segmentation processing, which segments an image based on color information and generates image data. In an example embodiment, the autonomous driving system 2000 may provide image data to the automotive storage device 1000. In an example embodiment, the autonomous driving system 2000 may provide RADAR information received from the RADAR sensor 500 and LiDAR information received from the LiDAR sensor 600 to the automotive storage device.

In an example embodiment, the automotive storage device 1000 may store data. In an example embodiment, the automotive storage device 1000 may be a solid-state drive (SSD).

In an example embodiment, the automotive storage device 1000 may store map information. In an example embodiment, the map information may include information about an advanced driver assistance system (ADAS) map or information about a high-definition (HD) map. In an example embodiment, the ADAS map may be a map used for autonomous driving of a first level or a second level. In an example embodiment, the HD map may be a map used for autonomous driving of a third level or higher. In an example embodiment, the map information may include information about road names, road slopes, road curvatures, traffic signs, maximum and minimum road speeds, and/or lanes.

In an example embodiment, the automotive storage device 1000 may identify a proper noun sign displayed on an external image of the vehicle 10 based on image data received from the autonomous driving system 2000. The proper noun sign may be a sign that includes proper nouns that refer to a specific area or specific object, such as a place name or street name. In an example embodiment, the automotive storage device 1000 may generate proper noun sign information regarding letters included in the proper noun sign.

In an example embodiment, the automotive storage device 1000 may receive GNSS position information from the GNSS receiver 200. In an example embodiment, the automotive storage device 1000 may generate proper noun sign position information that maps the current position of the vehicle 10 and proper noun sign information based on GNSS position information.

In an example embodiment, the automotive storage device 1000 may modify the position information included in the GNSS position information when the accuracy distance of the position information received from the GNSS receiver 200 exceeds a threshold distance. In an example embodiment, the automotive storage device 1000 may modify the position information based on road information and proper noun sign information included in the map (e.g., based on the result of comparing road information with proper noun sign information included in the map).

In an example embodiment, the automotive storage device 1000 may modify the position information based on RADAR information obtained by the RADAR sensor 500 and/or LiDAR information obtained by the LiDAR sensor 600.

In an example embodiment, the automotive storage device 1000 may modify position information based on image data generated according to front image information, front-left image information, and front-right image information. In an example embodiment, the automotive storage device 1000 may modify position information based on a first image data and a second image data generated based on a first image information and a second image information captured by the front camera 410. The second image information may be information captured at a point when a desired (or alternatively, predetermined) amount of time has elapsed from the time the first image information was captured.

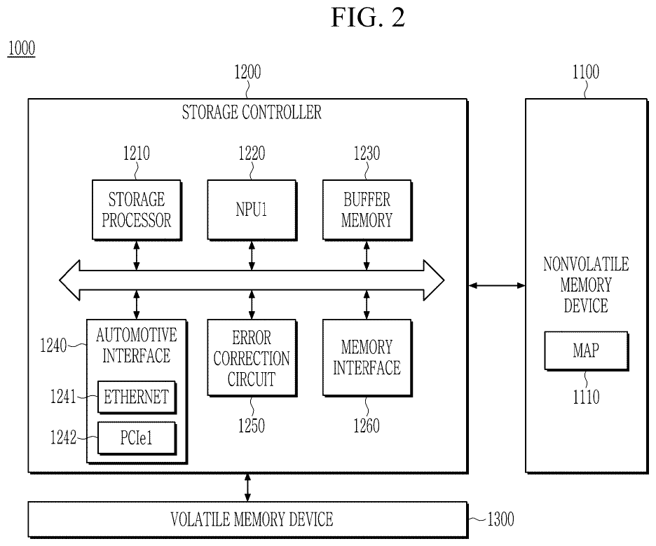

FIG. 2 illustrates an automotive storage device according to an example embodiment.

Referring to FIG. 2, the automotive storage device 1000 may include a non-volatile memory device 1100, a storage controller 1200, and a volatile memory device 1300.

In an example embodiment, the non-volatile memory device 1100 may store data. The non-volatile memory device 1100 may operate in response to the control of the storage controller 1200. In an example embodiment, the non-volatile memory device 1100 may be a NAND flash memory. The non-volatile memory device 1100 may include a plurality of memory blocks. The plurality of memory blocks may include a plurality of memory cells that store data. In an example embodiment, the non-volatile memory device 1100 may store a map information 1110.

In an example embodiment, the non-volatile memory device 1100 may receive a command and an address from the storage controller 1200 and perform an operation instructed by the command for a region selected by the address. The non-volatile memory device 1100 may perform a program operation (write operation) to store data in a region selected by the address, a read operation to read data, or an erase operation to delete data.

The storage controller 1200 may control the overall operation of the automotive storage device 1000.

In an example embodiment, the storage controller 1200 may control the non-volatile memory device 1100 to perform a write operation, a read operation, or an erase operation. The storage controller 1200 may provide a write command, address, and data to the non-volatile memory device 1100 during the write operation. The storage controller 1200 may provide a read command and address to the non-volatile memory device 1100 during the read operation. The storage controller 1200 may provide an erase command and address to the non-volatile memory device 1100 during the erase operation.

In an example embodiment, the storage controller 1200 may include a storage processor 1210, a first neural network processing unit 1220, a buffer memory 1230, an automotive interface 1240, an error correction circuit 1250, and a memory interface 1260.

In an example embodiment, the storage processor 1210 may control the overall operation of the storage controller 1200.

In an example embodiment, the first neural network processing unit 1220 may identify a proper noun sign displayed on (e.g., included in) an external image of the vehicle based on image data received from the autonomous driving system. The first neural network processing unit 1220 may extract features from image data and classify road signs based on the extracted features. The first neural network processing unit 1220 may generate proper noun sign information regarding letters of the proper noun sign based on image data. For example, the first neural network processing unit 1220 may perform optical character recognition (OCR) to recognize text in image data.

In an example embodiment, the buffer memory 1230 may be used as a cache memory or an operating memory of the storage controller 1200.

In an example embodiment, the automotive interface 1240 may include an ethernet interface 1241 and a first peripheral component interconnect express (PCIe) interface 1242.

In an example embodiment, the storage controller 1200 may communicate with the central gateway 100 via the ethernet interface 1241. In an example embodiment, the storage controller 1200 may communicate with the autonomous driving system 2000 via the first PCIe interface 1242.

In an example embodiment, the error correction circuit 1250 may perform an encoding operation to generate parity data for the data. The error correction circuit 1250 may perform an error correction operation on data read from the non-volatile memory device 1100. The error correction operation may be an operation to correct error bits included in data read from the non-volatile memory device 1100.

In an example embodiment, the memory interface 1260 may communicate with the non-volatile memory device 1100 or the volatile memory device 1300. The memory interface 1260 may provide data to the non-volatile memory device 1100 or the volatile memory device 1300, or receive data from the non-volatile memory device 1100 or the volatile memory device 1300.

In an example embodiment, the volatile memory device 1300 may temporarily store data received from the autonomous driving system 2000 and the non-volatile memory device 1100. In an example embodiment, the volatile memory device 1300 may temporarily store image data, RADAR information, and/or LiDAR information received from the autonomous driving system 2000. In an example embodiment, the volatile memory device 1300 may temporarily store proper noun sign information generated by the first neural network processing unit 1220. In an example embodiment, the volatile memory device 1300 may temporarily store the map information 1110.

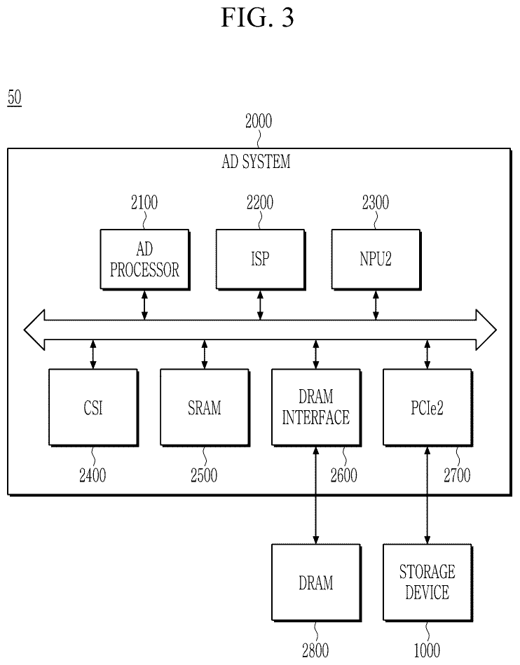

FIG. 3 illustrates an autonomous driving system according to an example embodiment.

Referring to FIG. 3, the autonomous driving system 2000 may include an autonomous driving processor 2100, an image signal processor 2200, a second neural network processing unit 2300, a camera serial interface 2400, a static random-access memory (SRAM) 2500, a dynamic random-access memory (DRAM) interface 2600, and a second PCIe interface 2700.

In an example embodiment, the autonomous driving processor 2100 may control the overall operation of the autonomous driving system 2000. The autonomous driving processor 2100 may control the speed of the vehicle 10 based on information received from the front camera 410, the front-left camera 420, the front-right camera 430, the RADAR sensor 500, and/or the LiDAR sensor 600.

In an example embodiment, the image signal processor 2200 may generate image data processed with image information received from the front camera 410, the front-left camera 420, and the front-right camera 430.

In an example embodiment, the second neural network processing unit 2300 may generate object information identified from an object displayed on an image inside or outside of the vehicle 10 based on image data generated by the image signal processor 2200. In an example embodiment, the object information may include information about a driver inside of the vehicle 10, information about the position of another vehicle outside of the vehicle 10, pedestrian information, information about traffic signs, and/or information about a drivable road area.

In an example embodiment, the camera serial interface 2400 may be connected to the front camera 410, the front-left camera 420, and/or the front-right camera 430. In an example embodiment, the camera serial interface 2400 may receive front image information, front-left image information and front right image information from the front camera 410, the front-left camera 420, and front-right image information from the front-right camera 430.

In an example embodiment, the SRAM 2500 may be used as a cache memory or operating memory of the autonomous driving system 2000.

In an example embodiment, the DRAM interface 2600 may be connected to the DRAM 2800. The DRAM 2800 may temporarily store data generated in the autonomous driving system 2000.

In an example embodiment, the second PCIe interface 2700 may be connected to the automotive storage device 1000. The second PCIe interface 2700 may provide data generated in the autonomous driving system 2000 to the automotive storage device 1000 or receive data from the automotive storage device 1000.

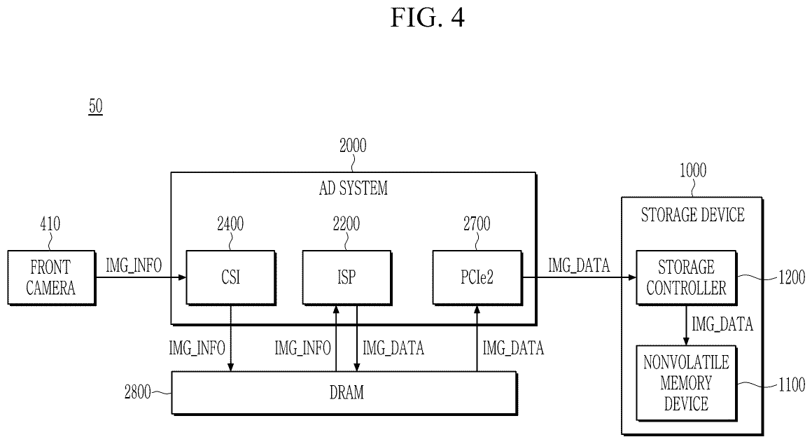

FIG. 4 illustrates an automotive storage device for storing image data according to an example embodiment.

Referring to FIG. 4, the front camera 410 may generate an image information IMG_INFO obtained by capturing a front image outside of the vehicle 10. The front camera 410 may provide the image information IMG_INFO to the autonomous driving system 2000.

In an example embodiment, the camera serial interface 2400 may receive the image information IMG_INFO and provide the image information IMG_INFO to the DRAM 2800.

In an example embodiment, the image signal processor 2200 may read the image information IMG_INFO from the DRAM 2800 and generate an image data IMG_DATA having processed the image information IMG_INFO. The image signal processor 2200 may provide the image data IMG_DATA to the DRAM 2800.

In an example embodiment, the second PCIe interface 2700 may provide the image data IMG_DATA received from the DRAM 2800 to the automotive storage device 1000.

In an example embodiment, the storage controller 1200 may receive the image data IMG_DATA and control the non-volatile memory device 1100 to store the image data IMG_DATA in the non-volatile memory device 1100.

In an example embodiment, the front camera 410 may continuously capture a front image of the outside of the vehicle 10 while the vehicle 10 is traveling. The front camera 410 may continuously provide the image information IMG_INFO to the autonomous driving system 2000. The autonomous driving system 2000 may continuously provide the image data IMG_DATA processed with the image information IMG_INFO to the automotive storage device 1000. The storage controller 1200 may continuously store the image data IMG_DATA in the non-volatile memory device 1100.

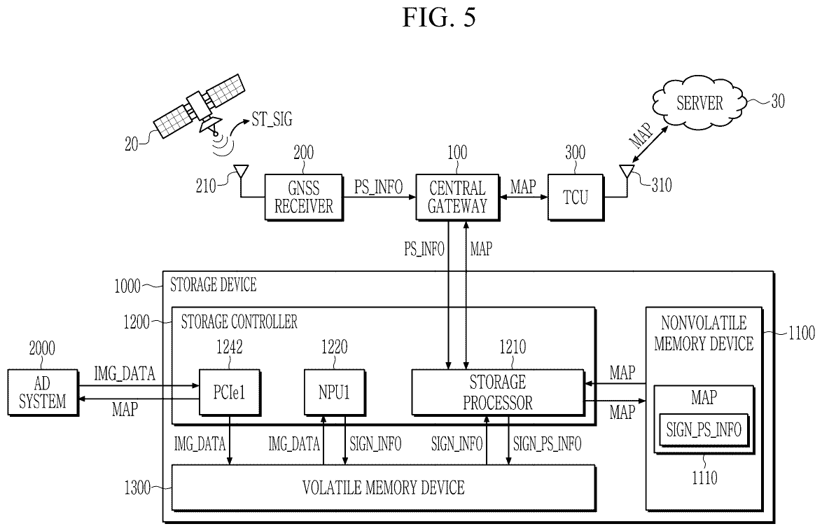

FIG. 5 illustrates the operation of an automotive storage device according to an example embodiment.

Referring to FIG. 5, the autonomous driving system 2000 may provide the image data IMG_DATA to the storage controller 1200.

In an example embodiment, the first PCIe interface 1242 may receive the image data IMG_DATA and provide the image data IMG_DATA to the volatile memory device 1300.

In an example embodiment, the first neural network processing unit 1220 may read the image data IMG_DATA from the volatile memory device 1300. In an example embodiment, the first neural network processing unit 1220 may identify a proper noun sign displayed on a front image outside of the vehicle 10 based on the image data IMG_DATA. In an example embodiment, the first neural network processing unit 1220 may generate a proper noun sign information SIGN_INFO regarding letters included in the proper noun sign based on the image data IMG_DATA. The first neural network processing unit 1220 may provide the proper noun sign information SIGN_INFO to the volatile memory device 1300.

In an example embodiment, the GNSS receiver 200 may receive a satellite signal ST_SIG from an artificial satellite 20 through the antenna 210. In an example embodiment, the GNSS receiver 200 may generate a GNSS position information PS_INFO regarding the position of the vehicle 10 based on the satellite signal ST_SIG. The GNSS receiver 200 may provide the GNSS position information PS_INFO to the storage controller 1200 through the central gateway 100.

In an example embodiment, the storage processor 1210 may receive the GNSS position information PS_INFO from the GNSS receiver 200 through the central gateway 100 and read the proper noun sign information SIGN_INFO from the volatile memory device 1300. In an example embodiment, the storage processor 1210 may generate a proper noun sign position information SIGN_PS_INFO including the GNSS position information PS_INFO and the proper noun sign information SIGN_INFO. The GNSS position information PS_INFO included in the proper noun sign position information SIGN_PS_INFO may be used as information indicating the position of a proper noun sign.

In an example embodiment, the storage processor 1210 may read the map information 1110 from the non-volatile memory device 1100. In an example embodiment, the storage processor 1210 may update the map information 1110 based on the proper noun sign position information SIGN_PS_INFO. In an example embodiment, the storage processor 1210 may provide the map information 1110 including the proper noun sign position information SIGN_PS_INFO to the autonomous driving system 2000 or the non-volatile memory device 1100.

In an example embodiment, the storage processor 1210 may provide a map information MAP including the proper noun sign position information SIGN_PS_INFO to an external server 30 through the central gateway 100 and the telematics communication unit 300.

In another example embodiment, the storage processor 1210 may receive the map information MAP including the proper noun sign position information SIGN_PS_INFO from the external server 30 through the telematics communication unit 300 and the central gateway 100. In an example embodiment, the storage processor 1210 may provide the map information MAP including the proper noun sign position information SIGN_PS_INFO to the autonomous driving system 2000 or the non-volatile memory device 1100.

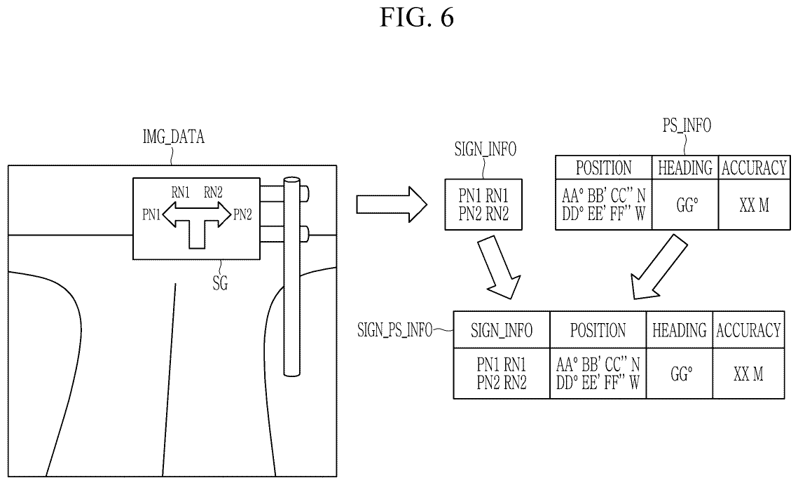

FIG. 6 illustrates an automotive storage device generating proper noun sign position information according to an example embodiment.

Referring to FIG. 6, the automotive storage device 1000 may receive the image data IMG_DATA from the autonomous driving system 2000. The image data IMG_DATA may be data representing an image obtained by capturing the front of the vehicle 10. In an example embodiment, the image data IMG_DATA may include data representing a three-way road and a proper noun sign SG in front of the vehicle 10.

In an example embodiment, the automotive storage device 1000 may identify letters included in the proper noun sign SG based on the image data IMG_DATA. The letters included in the proper noun sign SG may be a first proper noun PN1, a first road number RN1, a second proper noun PN2, and a second road number RN2. In an example embodiment, the automotive storage device 1000 may identify the first proper noun PN1, the first road number RN1, the second proper noun PN2, and the second road number RN2 included in the proper noun sign SG based on the image data IMG_DATA, and generate the proper noun sign information SIGN_INFO including the first proper noun PN1, the first road number RN1, the second proper noun PN2, and the second road number RN2.

In an example embodiment, the automotive storage device 1000 may receive the GNSS position information PS_INFO from the GNSS receiver 200. In an example embodiment, the GNSS position information PS_INFO may include a position information POSITION represented by latitude and longitude, a heading angle information HEADING indicating the direction in which the vehicle 10 is traveling, and/or an accuracy information ACCURACY indicating the accuracy of the position information POSITION.

In an example embodiment, the accuracy information ACCURACY may be information about accuracy distance that represents the accuracy of the position information POSITION as a distance (for example, XX meters (M)). In an example embodiment, the larger the value of the accuracy distance, the lower the accuracy of the position information POSITION, and the larger the error range of the position information POSITION may be. In an example embodiment, the smaller the value of the accuracy distance, the higher the accuracy of the position information POSITION, and the smaller the error range of the position information POSITION may be. Hereinafter, the accuracy information ACCURACY is expressed in units representing distance, but the accuracy information ACCURACY may also be expressed in units such as percentages, and is not limited to the above description.

In an example embodiment, the automotive storage device 1000 may generate the proper noun sign position information SIGN_PS_INFO based on the proper noun sign information SIGN_INFO and the GNSS position information PS_INFO. The proper noun sign position information SIGN_PS_INFO may include the proper noun sign information SIGN_INFO, the position information POSITION, the heading angle information HEADING, and/or the accuracy information ACCURACY. The position information POSITION included in the proper noun sign position information SIGN_PS_INFO may correspond to the position of the proper noun sign SG.

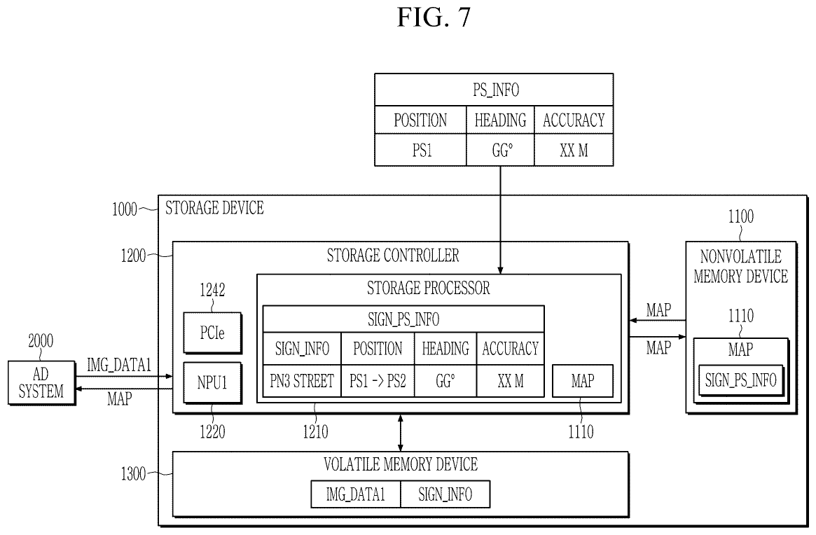

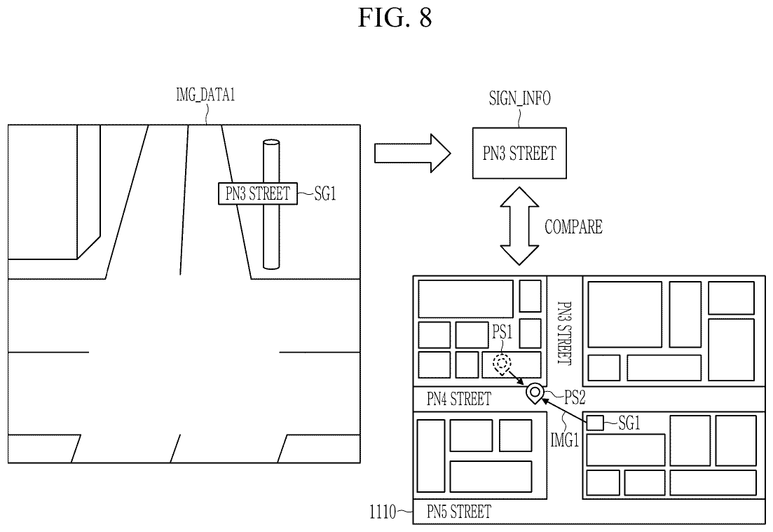

FIGS. 7 and 8 illustrate an automotive storage device that modifies position information based on a map and proper noun sign information according to an example embodiment.

Referring to FIGS. 7 and 8, the storage controller 1200 may receive a first image data IMG_DATA1 from the autonomous driving system 2000. The first image data IMG_DATA1 may be data representing a first image IMG1 outside of the vehicle 10 located at a second position PS2, as illustrated in FIG. 8. In an example embodiment, the first image data IMG_DATA1 may include data representing a four-way road, a building, and a first proper noun sign SG1 in front of the vehicle 10. The first image data IMG_DATA1 may be temporarily stored in the volatile memory device 1300.

In an example embodiment, the first neural network processing unit 1220 may read the first image data IMG_DATA1 from the volatile memory device 1300 and identify the first proper noun sign SG1 included in the first image data IMG_DATA1 based on the first image data IMG_DATA1.

In an example embodiment, the first neural network processing unit 1220 may identify a third proper noun road PN3 STREET corresponding to letters included in the first proper noun sign SG1 based on the first image data IMG_DATA1, and generate the proper noun sign information SIGN_INFO including the third proper noun road PN3 STREET. The first neural network processing unit 1220 may store the proper noun sign information SIGN_INFO in the volatile memory device 1300.

In an example embodiment, the storage processor 1210 may receive the GNSS position information PS_INFO from the GNSS receiver 200. The GNSS position information PS_INFO may include the position information POSITION indicating that the position of the vehicle 10 is a first position PS1. The first position PS1 may be a position represented by latitude and longitude, as described with reference to FIG. 6.

In an example embodiment, the storage processor 1210 may identify the accuracy of the first position PS1 indicated by the position information POSITION based on the accuracy information ACCURACY included in the GNSS position information PS_INFO. In an example embodiment, the storage processor 1210 may determine that the first position PS1 is different from the actual position of the vehicle 10 when an accuracy distance XX included in the accuracy information ACCURACY exceeds a threshold distance. In an example embodiment, as shown in FIG. 8, the actual position of the vehicle 10 may be the second position PS2, but the position information POSITION included in the GNSS position information PS_INFO may indicate the first position PS1. In an example embodiment, when the vehicle 10 is traveling in an urban canyon with many buildings, the accuracy distance XX of the GNSS position information PS_INFO may exceed the threshold distance.

In an example embodiment, the storage processor 1210 may read the map information 1110 from the non-volatile memory device 1100 when the accuracy distance XX included in the accuracy information ACCURACY exceeds a threshold distance and modify the position information POSITION based on the road information included in the map information 1110 and the proper noun sign information SIGN_INFO (e.g., based on the result of comparing the road information included in the map information 1110 with the proper noun sign information SIGN_INFO).

In an example embodiment, the storage processor 1210 may obtain driving road information on which the vehicle 10 is traveling based on road information included in the first position PS1 and the map information 1110.

In an example embodiment, as shown in FIG. 8, the storage processor 1210 may identify that the road on which the vehicle 10 is traveling is a fourth proper noun road PN4 STREET based on a result of comparing the first position PS1 with information about the third proper noun road PN3 STREET, the fourth proper noun road PN4 STREET, and a fifth proper noun road PN5 STREET included in the map information 1110, and may obtain the fourth proper noun road PN4 STREET as the driving road information.

In an example embodiment, the storage processor 1210 may obtain crossroad information including a proper noun identical to a proper noun sign based on a result of comparing road information included in the map information 1110 with the proper noun sign information SIGN_INFO. The crossroad information may be information about a road that intersects the road on which the vehicle 10 is traveling.

In an example embodiment, because the driving road on which the vehicle 10 is traveling is the fourth proper noun road PN4 STREET, the storage processor 1210 may identify that the third proper noun road PN3 STREET including the same proper noun as the first proper noun sign SG1 is a crossroad intersecting the driving road based on a result of comparing the proper noun sign information SIGN_INFO including the third proper noun road PN3 STREET with the information about the third proper noun road PN3 STREET, the fourth proper noun road PN4 STREET, and the fifth proper noun road PN5 STREET included in the map information 1110. In an example embodiment, the storage processor 1210 may obtain the third proper noun road PN3 STREET as the crossroad information.

In an example embodiment, the storage processor 1210 may determine the actual position of the vehicle 10 based on driving road information and crossroad information. In an example embodiment, the storage processor 1210 may determine the actual position of the vehicle 10 as the second position PS2 based on the fourth proper noun road PN4 STREET corresponding to a driving road and the third proper noun road PN4 STREET corresponding to a crossroad.

In an example embodiment, the storage processor 1210 may modify the position information POSITION included in the GNSS position information PS_INFO based on driving road information and crossroad information. In an example embodiment, the storage processor 1210 may determine the position of the vehicle 10 as the second position PS2 based on driving road information and crossroad information, and may modify the position information POSITION from the first position PS1 to the second position PS2.

In an example embodiment, the storage processor 1210 may read the proper noun sign information SIGN_INFO from the volatile memory device 1300 and generate the proper noun sign position information SIGN_PS_INFO including the proper noun sign information SIGN_INFO and modified position information. The modified position information may be information indicating that the position of the vehicle 10 is the second position PS2. In an example embodiment, the storage processor 1210 may generate the proper noun sign information SIGN_INFO including the third proper noun road PN3 STREET, the position information POSITION including the second position PS2, the heading angle information HEADING, and the proper noun sign position information SIGN_PS_INFO including the accuracy information ACCURACY.

In an example embodiment, the storage processor 1210 may update the map information 1110 based on the proper noun sign position information SIGN_PS_INFO and provide the map information 1110 including the proper noun sign position information SIGN_PS_INFO to the autonomous driving system 2000 or the non-volatile memory device 1100.

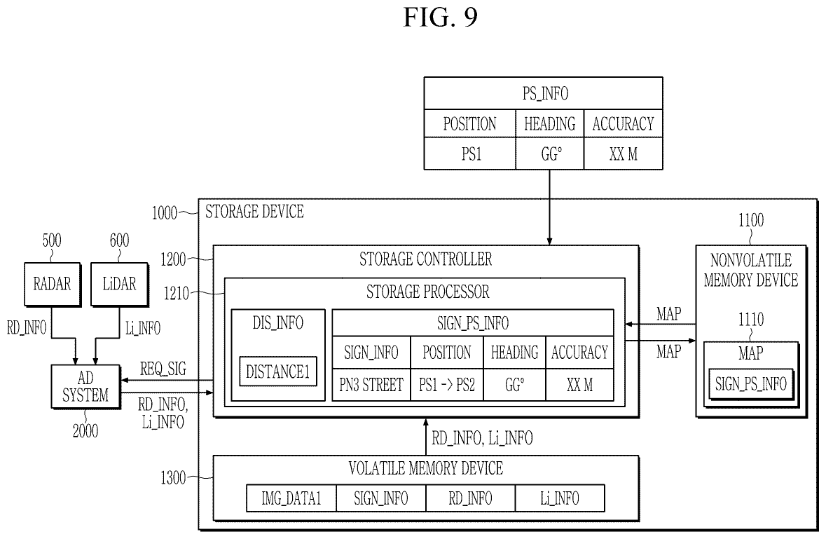

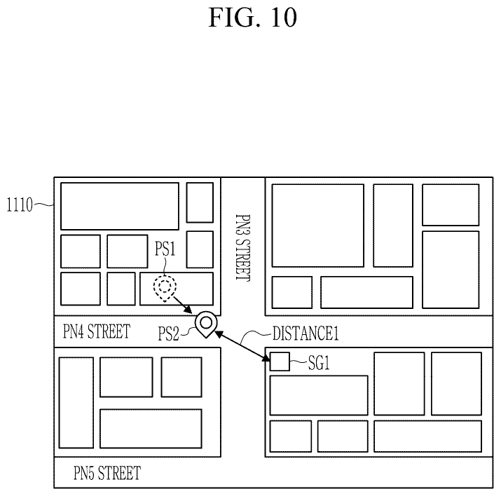

FIGS. 9 and 10 illustrate an automotive storage device that modifies position information based on RADAR information or LiDAR information according to an example embodiment.

Referring to FIGS. 9 and 10, the first neural network processing unit 1220 may generate the proper noun sign information SIGN_INFO including the third proper noun road PN3 STREET based on the first image data IMG_DATA1 and provide the proper noun sign information SIGN_INFO to the volatile memory device 1300.

In an example embodiment, the storage processor 1210 may receive the GNSS position information PS_INFO from the GNSS receiver 200. In an example embodiment, the storage processor 1210 may identify the accuracy of the first position PS1 indicated by the position information POSITION based on the accuracy information ACCURACY included in the GNSS position information PS_INFO. In an example embodiment, the storage processor 1210 may determine that the first position PS1 is different from the actual position of the vehicle 10 when an accuracy distance XX included in the accuracy information ACCURACY exceeds a threshold distance.

In an example embodiment, the storage processor 1210 may provide a request signal REQ_SIG to the autonomous driving system 2000 requesting additional information when the accuracy distance XX included in the accuracy information ACCURACY exceeds a threshold distance. In an example embodiment, the additional information may include a RADAR information RD_INFO generated by the RADAR sensor 500 or a LiDAR information Li_INFO generated by the LiDAR sensor 600.

In an example embodiment, the autonomous driving system 2000 may control the RADAR sensor 500 to emit electromagnetic waves toward the first proper noun sign SG1 in front of the vehicle 10 in response to the request signal REQ_SIG. In an example embodiment, the RADAR sensor 500 may receive reflected waves that are reflected when electromagnetic waves collide with the first proper noun sign SG1, and generate the RADAR information RD_INFO based on the electromagnetic waves and the reflected waves. The RADAR sensor 500 may provide the RADAR information RD_INFO to the autonomous driving system 2000.

In an example embodiment, the autonomous driving system 2000 may control the LiDAR sensor 600 to emit a laser pulse toward the front of the vehicle 10 in response to the request signal REQ_SIG. In an example embodiment, the LiDAR sensor 600 may receive reflected waves that are reflected when a laser pulse collides with the first proper noun sign SG1, and generate the LiDAR information Li_INFO based on the laser pulse and the reflected waves.

In an example embodiment, the autonomous driving system 2000 may provide the RADAR information RD_INFO and the LiDAR information Li_INFO to the automotive storage device 1000 in response to the request signal REQ_SIG. The RADAR information RD_INFO and the LiDAR information Li_INFO may be stored in the volatile memory device 1300.

In an example embodiment, the storage processor 1210 may read the RADAR information RD_INFO or the LiDAR information Li_INFO from the volatile memory device 1300, calculate a first distance DISTANCE1 corresponding to a distance between the vehicle 10 and the first proper noun sign SG1 based on the RADAR information RD_INFO or the LiDAR information Li_INFO, and generate a distance information DIS_INFO including the first distance DISTANCE1. In an example embodiment, the storage processor 1210 may determine the position of the vehicle 10 as the second position PS2 based on the distance information DIS_INFO and modify the position information POSITION from the first position PS1 to the second position PS2.

In an example embodiment, the storage processor 1210 may read the proper noun sign information SIGN_INFO from the volatile memory device 1300 and generate the proper noun sign position information SIGN_PS_INFO including the proper noun sign information SIGN_INFO, the position information POSITION including the second position PS2, the heading angle information HEADING, and the accuracy information ACCURACY. In an example embodiment, the storage processor 1210 may update the map information 1110 based on the proper noun sign position information SIGN_PS_INFO and provide the map information 1110 including the proper noun sign position information SIGN_PS_INFO to the non-volatile memory device 1100.

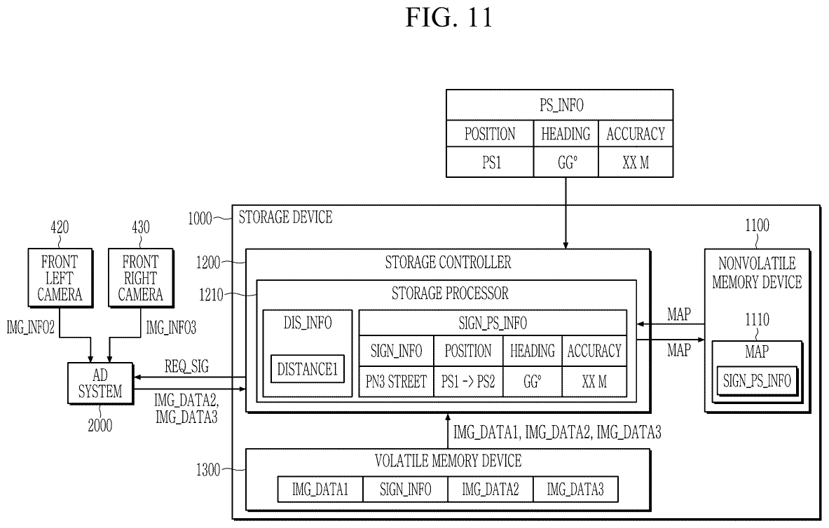

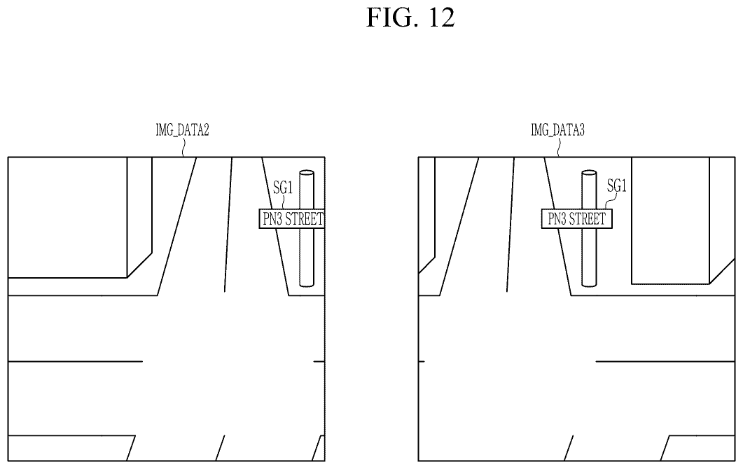

FIGS. 11 and 12 illustrate an automotive storage device that modifies position information based on additional external images received from a front-left camera and a front-right camera according to an example embodiment.

Referring to FIGS. 11 and 12, the storage processor 1210 may receive the GNSS position information PS_INFO from the GNSS receiver 200 and identify the accuracy of the first position PS1 indicated by the position information POSITION based on the accuracy information ACCURACY included in the GNSS position information PS_INFO.

In an example embodiment, the storage processor 1210 may provide the request signal REQ_SIG requesting additional information to the autonomous driving system 2000 when the accuracy distance XX included in the accuracy information ACCURACY exceeds a threshold distance. In an example embodiment, the additional information may include a second image data IMG_DATA2 generated based on a second image information IMG_INFO2 captured by the front-left camera 420 and a third image data IMG_DATA3 generated based on a third image information IMG_INFO3 captured by the front-right camera 430.

In an example embodiment, the autonomous driving system 2000 may control the front-left camera 420 and the front-right camera 430 in response to the request signal REQ_SIG to capture a front-left image outside of the vehicle 10 and the front-right image outside of the vehicle, respectively.

In an example embodiment, the front-left camera 420 may capture a front-left image outside of the vehicle 10 to generate front-left image information and provide the front-left image information to the autonomous driving system 2000 as the second image information IMG_INFO2. In an example embodiment, the front-right camera 430 may capture a front-right image outside of the vehicle 10 to generate front-right image information and provide the front-right image information to the autonomous driving system 2000 as the third image information IMG_INFO3.

In an example embodiment, the autonomous driving system 2000 may generate the second image data IMG_DATA2 and the third image data IMG_DATA3 processed with the second image information IMG_INFO2 and the third image information IMG_INFO3, respectively, and provide the second image data IMG_DATA2 and the third image data IMG_DATA3 to the automotive storage device 1000. The second image data IMG_DATA2 and the third image data IMG_DATA3 may be stored in the volatile memory device 1300.

In an example embodiment, the storage processor 1210 may read the first image data IMG_DATA1, the second image data IMG_DATA2, and the third image data IMG_DATA3 from the volatile memory device 1300. In an example embodiment, the storage processor 1210 may calculate the first distance DISTANCE1 corresponding to the distance between the vehicle 10 and the first proper noun sign SG1 based on the first image data IMG_DATA1, the second image data IMG_DATA2, and the third image data IMG_DATA3, and generate the distance information DIS_INFO including the first distance DISTANCE1. In an example embodiment, the storage processor 1210 may calculate the first distance DISTANCE1 based on the difference in position of each of the first proper noun signs SG1 represented by the first image data IMG_DATA1, the second image data IMG_DATA2, and the third image data IMG_DATA3.

In an example embodiment, the storage processor 1210 may determine the position of the vehicle 10 as the second position PS2 based on the distance information DIS_INFO and modify the position information POSITION from the first position PS1 to the second position PS2.

In an example embodiment, the storage processor 1210 may generate proper noun sign position information SIGN_PS_INFO including proper noun sign information SIGN_INFO and the accuracy information ACCURACY, the proper noun sign information SIGN_INFO including the third proper noun road PN3 STREET, the position information POSITION including the second position PS2, the heading angle information HEADING. In an example embodiment, the storage processor 1210 may update the map information 1110 based on the proper noun sign position information SIGN_PS_INFO and provide the map information 1110 including the proper noun sign position information SIGN_PS_INFO to the non-volatile memory device 1100.

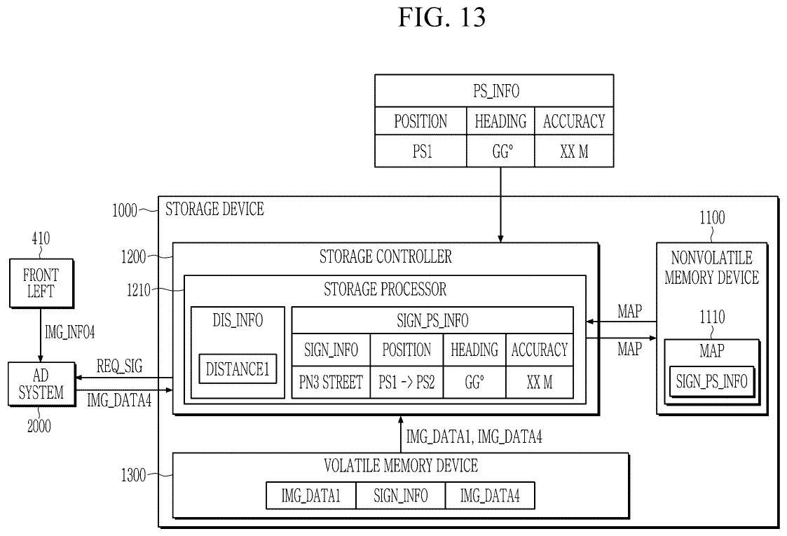

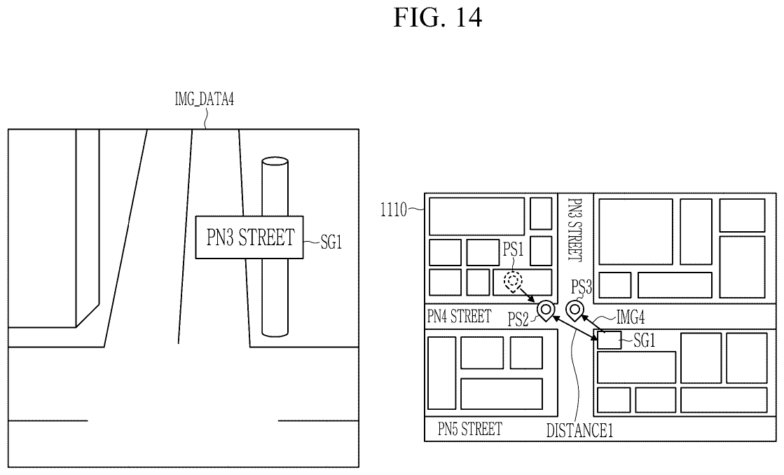

FIGS. 13 and 14 illustrate an automotive storage device that modifies position information based on additional external images received from a front camera according to an example embodiment.

Referring to FIGS. 13 and 14, the storage processor 1210 may receive the GNSS position information PS_INFO from the GNSS receiver 200, and may provide the request signal REQ_SIG to the autonomous driving system 2000 requesting additional information when the accuracy distance XX included in the accuracy information ACCURACY of the GNSS position information PS_INFO exceeds a threshold distance. In an example embodiment, the additional information may include a fourth image data IMG_DATA4 generated based on a fourth image information IMG_INFO4 captured by the front camera 410. In an example embodiment, the fourth image information IMG_INFO4 may be information captured at a point when a desired (or alternatively, predetermined) amount of time has elapsed from the time when the first image information IMG_INFO1 was captured by the front camera 410.

In an example embodiment, the autonomous driving system 2000 may control the front camera 410 to capture a front image of the outside of the vehicle 10 in response to the request signal REQ_SIG.

In an example embodiment, the front camera 410 may generate front image information obtained by capturing a front image outside of the vehicle 10 and provide the front image information to the autonomous driving system 2000 as fourth image information IMG_INFO4.

In an example embodiment, the autonomous driving system 2000 may generate the fourth image data IMG_DATA4 processed with the fourth image information IMG_INFO4 (e.g., generate the fourth image information IMG_INFO4 based on or processing the fourth image data IMG_DATA4) and provide the fourth image data IMG_DATA4 to the automotive storage device 1000. In an example embodiment, the fourth image data IMG_DATA4 may be stored in the volatile memory device 1300.

In an example embodiment, the storage processor 1210 may read the first image data IMG_DATA1 and the fourth image data IMG_DATA4 from the volatile memory device 1300. In an example embodiment, the storage processor 1210 may calculate the first distance DISTANCE1 corresponding to a distance between the vehicle 10 at the second position PS2 and the first proper noun sign SG1 based on the first image data IMG_DATA1 and the fourth image data IMG_DATA4, and generate the distance information DIS_INFO including the first distance DISTANCE1. In an example embodiment, the storage processor 1210 may calculate the first distance DISTANCE1 based on the difference between the number of pixels corresponding to the first proper noun sign SG1 of the first image data IMG_DATA1 and the number of pixels corresponding to the first proper noun sign SG1 of the fourth image data IMG_DATA4.

In an example embodiment, as shown in FIG. 8, the first image data IMG_DATA1 may be data representing a first image IMG1 outside of the vehicle 10 located at the second position PS2. In an example embodiment, as shown in FIG. 14, the fourth image data IMG_DATA4 may be data representing a fourth image IMG4 outside of the vehicle 10 located at a third position PS3 while the vehicle 10 is traveling from the second position PS2 to the third position PS3.

In an example embodiment, the fourth image data IMG_DATA4 may be data generated at a point when a desired (or alternatively, predetermined) amount of time has elapsed from the time when the first image data IMG_DATA1 was generated.

In an example embodiment, the first image data IMG_DATA1 may be data generated when the vehicle 10 is located at the second position PS2. In an example embodiment, the fourth image data IMG_DATA4 may be data generated when the vehicle 10 is located at the third position PS3. In an example embodiment, the fourth image data IMG_DATA4 may be data generated when the vehicle 10 moves from the second position PS2 to the third position PS3.

In an example embodiment, the size of the first proper noun sign SG1 represented by the fourth image data IMG_DATA4 shown in FIG. 14 may be larger than the size of the first proper noun sign SG1 represented by the first image data IMG_DATA1 shown in FIG. 8.

In an example embodiment, the storage processor 1210 may modify the position information from the first position PS1 to the second position PS2 based on the distance information DIS_INFO and generate the proper noun sign information SIGN_INFO including the third proper noun road PN3 STREET, the position information POSITION including the second position PS2, the heading angle information HEADING, and the proper noun sign position information SIGN_PS_INFO including the accuracy information ACCURACY.

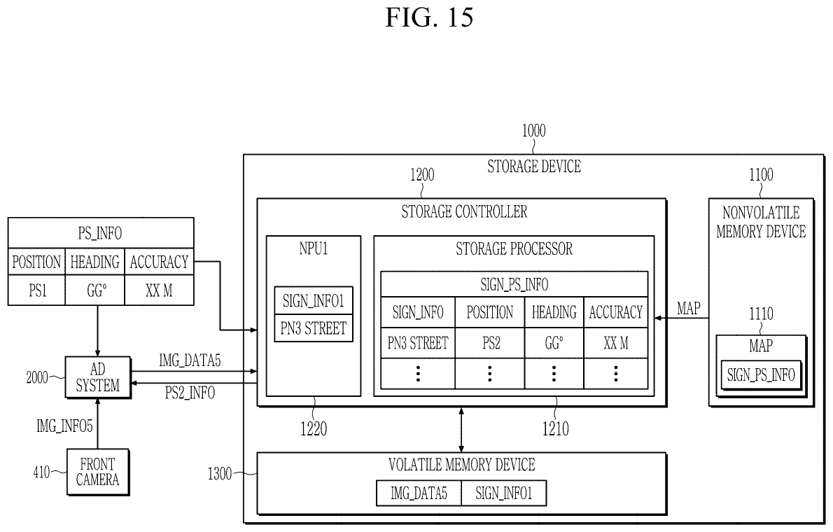

FIG. 15 illustrates an automotive storage device that provides a second position information generated based on proper noun sign position information according to an example embodiment to an autonomous driving system.

Referring to FIG. 15, a non-volatile memory device may store the map information including the proper noun sign position information.

In an example embodiment, the front camera 410 may generate a fifth image information IMG_INFO5 obtained by capturing a front image of the vehicle 10. The front camera 410 may provide the fifth image information IMG_INFO5 to the autonomous driving system 2000.

In an example embodiment, the autonomous driving system 2000 may generate the fifth image data IMG_DATA5 processed with the fifth image information IMG_INFO5 (e.g., generate the fifth image information IMG_INFO5 based on or processing the fifth image data IMG_DATA5) and provide the fifth image data IMG_DATA5 to the automotive storage device 1000. In an example embodiment, the fifth image data IMG_DATA5 may be stored in the volatile memory device 1300.

In an example embodiment, the first neural network processing unit 1220 may read the fifth image data IMG_DATA5 from the volatile memory device 1300 and identify the first proper noun sign SG1 displayed on the front image of the vehicle 10 based on the fifth image data IMG_DATA5.

In an example embodiment, the first neural network processing unit 1220 may identify the third proper noun road PN3 STREET corresponding to letters included in the first proper noun sign SG1 based on the fifth image data IMG_DATA5, and generate a first proper noun sign information SIGN_INFO1 including the third proper noun road PN3 STREET. The first neural network processing unit 1220 may store the first proper noun sign information SIGN_INFO1 in the volatile memory device 1300.

In an example embodiment, the GNSS receiver 200 may provide GNSS position information to an autonomous driving system and an automotive storage device.

In an example embodiment, the storage processor may determine that the first position PS1 included in the GNSS position information PS_INFO is different from the actual position of the vehicle 10 when the accuracy distance XX included in the accuracy information ACCURACY of the GNSS position information PS_INFO exceeds a threshold distance. In an example embodiment, the storage processor 1210 may read the map information 1110 including the proper noun sign position information SIGN_PS_INFO from the non-volatile memory device 1100 when the accuracy distance XX included in the accuracy information ACCURACY exceeds a threshold distance, and compare the proper noun sign position information SIGN_PS_INFO with the first proper noun sign information SIGN_INFO1.

In an example embodiment, the storage processor 1210 may identify the position information POSITION corresponding to the third proper noun road PN3 STREET based on based on the proper noun sign position information SIGN_PS_INFO and the first proper noun sign information SIGN_INFO1 (e.g., based on a result of comparing the proper noun sign position information SIGN_PS_INFO and the first proper noun sign information SIGN_INFO1). In an example embodiment, the storage processor 1210 may identify that the position information POSITION of the third proper noun road PN3 STREET included in the first proper noun sign information SIGN_INFO1 is the second position PS2 based on the proper noun sign position information SIGN_PS_INFO. In an example embodiment, the storage processor 1210 may provide a second position information PS2_INFO indicating the second position PS2 to the autonomous driving system 2000.

In an example embodiment, the autonomous driving system 2000 may receive the GNSS position information PS_INFO including the first position PS1 from the GNSS receiver 200 and receive the second position information PS2_INFO from the automotive storage device 1000. In an example embodiment, the autonomous driving system 2000 may determine that the first position PS1 is different from the actual position of the vehicle 10 when the accuracy distance XX included in the accuracy information ACCURACY of the GNSS position information PS_INFO exceeds a threshold distance and may determine the second position PS2 received from the automotive storage device 1000 as the actual position of the vehicle 10. In an example embodiment, the autonomous driving system 2000 may control driving of the vehicle 10 based on the second position information PS2_INFO received from the automotive storage device 1000.

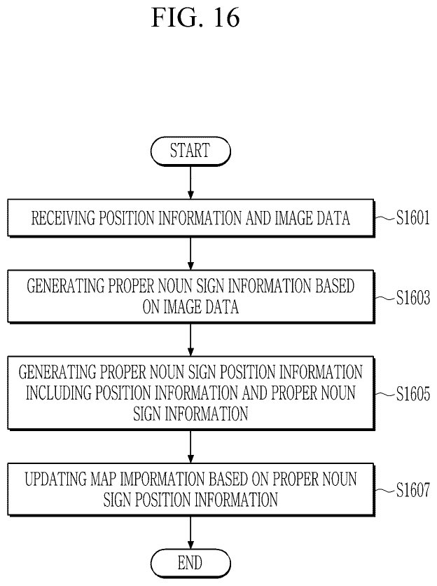

FIG. 16 is a flowchart illustrating an automotive storage device generating proper noun sign position information according to an example embodiment.

Referring to FIG. 16, in S1601, the automotive storage device 1000 may receive position information and image data. In an example embodiment, the position information may be information indicating the position of the vehicle 10. In an example embodiment, the image data may be data generated based on image information obtained by capturing an external image of the vehicle 10.

In an example embodiment, the position information may be received from a GNSS receiver and image data may be received from an autonomous driving system.

In S1603, the automotive storage device 1000 may generate proper noun sign information based on image data. In an example embodiment, the automotive storage device may identify a proper noun sign displayed in an image outside of the vehicle 10 based on image data and generate proper noun sign information regarding letters included in the proper noun sign.

In S1605, the automotive storage device 1000 may generate proper noun sign position information including position information and proper noun sign information. In an example embodiment, the proper noun sign position information may further include heading angle information indicating the direction in which the vehicle is traveling and accuracy information indicating the accuracy of the position information.

In S1607, the automotive storage device 1000 may update map information based on proper noun sign position information. In an example embodiment, the automotive storage device 1000 may provide map information including proper noun sign position information to the autonomous driving system or an external server. In an example embodiment, the automotive storage device 1000 may store map information including proper noun sign position information in a non-volatile memory device.

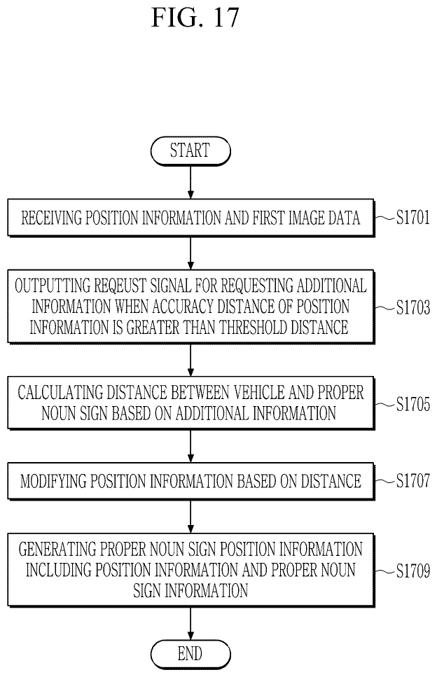

FIG. 17 is a flowchart illustrating an automotive storage device that modifies position information based on additional information according to an example embodiment.

Referring to FIG. 17, in S1701, the automotive storage device 1000 may receive position information and the first image data. In an example embodiment, the first image data may be data generated based on a first front image information captured by the front camera. In an example embodiment, the automotive storage device 1000 may generate proper noun sign information based on the first image data.

In S1703, the automotive storage device 1000 may output a request signal for requesting additional information when the accuracy distance of the position information exceeds a threshold distance. In an example embodiment, the automotive storage device 1000 may determine that the position indicated by the position information is different from the actual position of the vehicle when the accuracy distance of the position information exceeds a threshold distance. In an example embodiment, the additional information may include RADAR information generated by a RADAR sensor and/or LiDAR information generated by a LiDAR sensor. In an example embodiment, the additional information may include a second image data generated based on front-left image information captured by the front-left camera and/or a third image data generated based on front-right image information captured by the front-right camera. In an example embodiment, the additional information may be a fourth image data generated based on a second front image information captured by the front camera. The fourth image data may be data generated at a point when a desired (or alternatively, predetermined) amount of time has elapsed from the time the first image data was generated. In an example embodiment, the first image data and the fourth image data may be data generated when the vehicle is located at different positions.

In S1705, the automotive storage device 1000 may calculate the distance between the vehicle and the proper noun sign based on additional information.

In S1707, the automotive storage device 1000 may modify the position information based on the distance.

In S1709, the automotive storage device 1000 may generate proper noun sign information including position information and proper noun sign information.

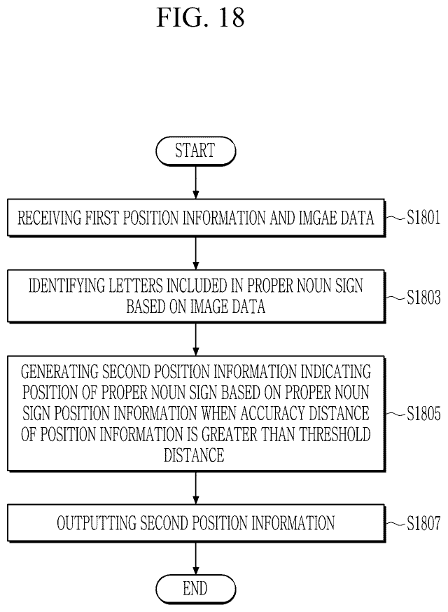

FIG. 18 is a flowchart illustrating an automotive storage device that outputs second position information generated based on proper noun sign position information according to an example embodiment.

Referring to FIG. 18, in S1801, the automotive storage device 1000 may receive a first position information and image data. In an example embodiment, the first position information may be received from a GNSS receiver, and the image data may be received from an autonomous driving system.

In S1803, the automotive storage device 1000 may identify letters included in a proper noun sign based on image data.

In S1805, the automotive storage device 1000 may generate a second position information indicating the position of the proper noun sign based on the proper noun sign position information when the accuracy distance of the position information exceeds a threshold distance. In an example embodiment, the automotive storage device 1000 may identify a position corresponding to letters included in a proper noun sign based on letters included in a proper noun sign and proper noun sign information included in proper noun sign position information (e.g., based on a result of comparing letters included in a proper noun sign with proper noun sign information included in proper noun sign position information).

In S1807, the automotive storage device 1000 may output second position information. In an example embodiment, the autonomous driving system 2000 may receive the first position information from the GNSS receiver and the second position information from the automotive storage device. In an example embodiment, the autonomous driving system 2000 may control driving of the vehicle based on the second position information when the accuracy distance of the first position information exceeds a threshold distance.

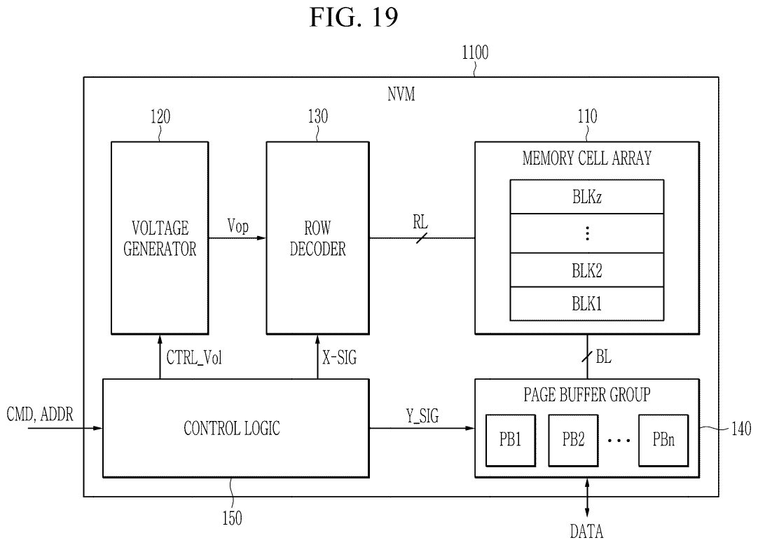

FIG. 19 illustrates a non-volatile memory device according to an example embodiment.

Referring to FIG. 19, the non-volatile memory device 1100 may include a memory cell array 110, a voltage generator 120, a row decoder 130, a page buffer group 140, and a control logic 150.

The memory cell array 110 may include a plurality of memory blocks BLK1 to BLKz. The plurality of memory blocks BLK1 to BLKz may be connected to the row decoder 130 through row lines RL. The plurality of memory blocks BLK1 to BLKz may be connected to the page buffer group 140 through bit lines BL. Each of the plurality of memory blocks BLK1 to BLKz may include a plurality of memory cells. In an example embodiment, the plurality of memory cells may be non-volatile memory cells. In an example embodiment, the plurality of memory blocks BLK1 to BLKz may store map information and image data. In an embodiment, the map information may include proper noun sign position information.

The voltage generator 120 may generate operating voltages Vop using an external power voltage supplied to the non-volatile memory device 1100. The voltage generator 120 may operate in response to the control of the control logic 150.

In an example embodiment, the voltage generator 120 may generate the operating voltages Vop used for program operations, read operations, and erase operations. For example, the voltage generator 120 may generate a program voltage, a pass voltage, a read voltage, and an erase voltage. The operating voltages Vop may be supplied to the memory cell array 110 by the row decoder 130.

The row decoder 130 may be connected to the memory cell array 110 through the row lines RL. The row lines RL may include string select lines, word lines, and ground select lines.

The row decoder 130 may operate in response to the control of the control logic 150. The row decoder 130 may receive a row signal X_SIG from the control logic 150. In an example embodiment, the row decoder 130 may select at least one word line among a plurality of word lines based on the row signal X_SIG and apply the operating voltages Vop provided from the voltage generator 120 to at least one word line.

In an example embodiment, the row decoder 130 may apply a program voltage to a selected word line among a plurality of word lines during a program operation, and apply a pass voltage at a level lower than the program voltage to unselected word lines. The row decoder 130 may apply a verification voltage to a selected word line during a program verification operation and apply a verification pass voltage at a higher level than the verification voltage to unselected word lines.

The row decoder 130 may apply a read voltage to a selected word line during a read operation and apply a read pass voltage at a level higher than the read voltage to unselected word lines.

The page buffer group 140 may include a plurality of page buffers PB1 to PBn. The plurality of page buffers PB1 to PBn may each be connected to a plurality of memory cells included in the memory cell array 110 through the bit lines BL. The plurality of page buffers PB1 to PBn may operate in response to the control of the control logic 150.

In an example embodiment, the plurality of page buffers PB1 to PBn may receive data DATA from the storage controller 1200. The plurality of page buffers PB1 to PBn may select at least one bit line among the bit lines BL based on a column signal Y_SIG received from the control logic 150.

In an example embodiment, the plurality of page buffers PB1 to PBn may transmit data received from the storage controller 1200 to a plurality of memory cells of the memory cell array 110 through the bit lines BL during a program operation. The plurality of memory cells may be programmed according to received data. The plurality of page buffers PB1 to PBn may sense data stored in the plurality of memory cells through the bit lines BL during a program verification operation. The plurality of page buffers PB1 to PBn may sense data stored in memory cells through the bit lines BL during a read operation and store the sensed data in the plurality of page buffers PB1 to PBn.

The control logic 150 may be connected to the voltage generator 120, the row decoder 130, the page buffer group 140, and a read level register group 160.

The control logic 150 may control the overall operation of the non-volatile memory device 1100. The control logic 150 may control the voltage generator 120, the row decoder 130, and the page buffer group 140 to perform an operation corresponding to the command in response to a command received from the storage controller 1200.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

According to some example embodiments, an automotive storage device may identify a proper noun sign displayed on an image data of a surrounding of a vehicle and receive GNSS position information regarding a position of the vehicle from a satellite, and when an accuracy information included in the GNSS position information exceeds a threshold distance, the automotive storage device may modify position information included in the GNSS position information based on road information included in map information, which is stored in a nonvolatile memory device, and the proper noun sign information. Thus, the control of an autonomous driving system may be controlled with improved precision.

While some example embodiments of the present disclosure have been described in detail, it is to be understood that the disclosure is not limited to the disclosed example embodiments, but on the contrary, is intended to cover various modifications and equivalent arrangements included within the spirit and scope of the appended claims.

What is claimed is:

1. An automotive storage device, comprising:
a non-volatile memory device configured to store map information, the map information including road information; and
a storage controller configured to
receive a first image data obtained by capturing a proper noun sign and position information of a vehicle,
generate proper noun sign information regarding letters included in the proper noun sign based on the first image data,
modify the position information based on the road information and the proper noun sign information when an accuracy distance of the position information exceeds a threshold distance, and
generate proper noun sign position information including the modified position information and the proper noun sign information.

2. The automotive storage device of claim 1, wherein
the storage controller is configured to output a signal to an outside requesting a second image data obtained by additionally capturing the proper noun sign, when the accuracy distance of the position information exceeds the threshold distance.

3. The automotive storage device of claim 2, wherein
the storage controller is configured to
receive the second image data,
calculate a distance between the vehicle and the proper noun sign based on the first image data and the second image data, and
modify the position information based on the distance.

4. The automotive storage device of claim 2, wherein
the first image data and the second image data are captured from different cameras of the vehicle, respectively.

5. The automotive storage device of claim 2, wherein
the second image data is generated at a point when an amount of time has elapsed from a first time the first image data is generated.

6. The automotive storage device of claim 1, wherein
the storage controller is configured to output a signal requesting RADAR information generated by a RADAR sensor of the vehicle to an outside, when the accuracy distance of the position information exceeds the threshold distance.

7. The automotive storage device of claim 6, wherein
the storage controller is configured to
receive the RADAR information from the outside,
calculate a distance between the vehicle and the proper noun sign based on the RADAR information, and
modify the position information based on the distance.

8. The automotive storage device of claim 1, wherein
the storage controller is configured to
obtain driving road information on which the vehicle is traveling based on the position information and the map information,
obtain intersection road information including the proper noun sign from the map information based on the proper noun sign information, and
modify the position information based on the driving road information and the intersection road information.

9. The automotive storage device of claim 1, wherein
the storage controller is configured to
update the map information based on the proper noun sign position information, and
provide the map information to an autonomous driving system configured to control driving of the vehicle.

10. The automotive storage device of claim 1, wherein
the storage controller is configured to
receive a third image data obtained by capturing the proper noun sign,
identify a position of the proper noun sign based on the proper noun sign position information, and
provide position information indicating the position of the proper noun sign to an autonomous driving system configured to control driving of the vehicle.

11. The automotive storage device of claim 1, wherein
the storage controller is configured to
receive heading angle information indicating a driving direction of the vehicle, and
generate proper noun sign position information further including the heading angle information.

12. The automotive storage device of claim 1, wherein
the storage controller is configured to provide the proper noun sign position information to an external server.

13. A vehicle system, comprising:
a global navigation satellite system (GNSS) receiver configured to generate position information of a vehicle;
a first camera configured to generate a first image information obtained by capturing a proper noun sign;
an autonomous driving system configured to generate a first image data based on the first image information; and
an automotive storage device configured to
generate proper noun sign information regarding letters included in the proper noun sign based on the first image data,
provide a request signal requesting additional information to the autonomous driving system when an accuracy distance of the position information exceeds a threshold distance,
modify the position information based on the additional information received from the autonomous driving system, and
generate proper noun sign position information including the modified position information and the proper noun sign information.

14. The vehicle system of claim 13, further comprising:
a RADAR sensor,
wherein the autonomous driving system is configured to provide RADAR information received from the RADAR sensor as additional information to the automotive storage device in response to the request signal, and
the automotive storage device is configured to
calculate a distance between the vehicle and the proper noun sign based on the RADAR information, and
modify the position information based on the distance.

15. The vehicle system of claim 13, further comprising:
a second camera configured to capture the proper noun sign and generate a second image information,
wherein the autonomous driving system is configured to
generate a second image data based on the second image information in response to the request signal, and
provide the second image data to the automotive storage device as the additional information, and
the automotive storage device is configured to
calculate a distance between the vehicle and the proper noun sign based on the first image data and the second image data, and
modify the position information based on the distance.

16. The vehicle system of claim 15, wherein
the first camera is at a front of the vehicle, and
the second camera is at a front-left or a front-right of the vehicle.

17. The vehicle system of claim 13, wherein
the autonomous driving system is configured to
receive a third image information obtained by capturing the proper noun sign from the first camera at a point when an amount of time has elapsed from the time, when the first image information was generated in response to the request signal,
generate a third image data based on the third image information, and
provide the third image data as the additional information to the automotive storage device, and
the automotive storage device is configured to
calculate a distance between the vehicle and the proper noun sign based on the first image data and the third image data, and
modify the position information based on the distance.

18. The vehicle system of claim 13, wherein
the autonomous driving system configured to
receive a fourth image information obtained by capturing the proper noun sign from the first camera, and
provide a fourth image data based on the fourth image information to the automotive storage device, and
the automotive storage device is configured to
identify a position of the proper noun sign indicated by the fourth image data based on the proper noun sign position information, and
provide position information indicating the position of the proper noun sign to the autonomous driving system.

19. A vehicle, comprising:
a global navigation satellite system (GNSS) receiver configured to generate a first position information of the vehicle;
a camera configured to generate image information obtained by capturing an external image of the vehicle;
an autonomous driving system configured to generate image data based on the image information; and
an automotive storage device including a non-volatile memory device and a storage controller, the non-volatile memory device configured to store proper noun sign position information including proper noun sign information and information regarding a position of a proper noun sign, the storage controller configured to identify the proper noun sign included in the external image of the vehicle based on the image data, generate second position information regarding the position of the proper noun sign based on the proper noun sign position information when an accuracy distance of the first position information exceeds a threshold distance, and provide the second position information to the autonomous driving system.

20. The vehicle of claim 19, wherein
the autonomous driving system is configured to
receive the first position information and the second position information, and
control driving of the vehicle based on the second position information when the accuracy distance of the first position information exceeds a threshold distance.
